(19) United States
(12) Patent Application Publication
(10) Pub. No.: US 2024/0005290 A1
(43) Pub. Date: Jan. 4, 2024

(54) METHOD FOR PROVIDING DIGITAL CURRENCY PLATFORM SERVICE AND SYSTEM FOR SAME

(71) Applicant: MOFIN CO., LTD., Seoul (KR)

(72) Inventor: Joon Mo KIM, Seoul (KR)

(73) Assignee: MOFIN CO., LTD., Seoul (KR)

(21) Appl. No.: 18/466,806

(22) Filed: Sep. 13, 2023

Related U.S. Application Data
(63) Continuation of application No. PCT/KR2022/003806, filed on Mar. 18, 2022.

(30) Foreign Application Priority Data
Mar. 18, 2021 (KR) 10-2021-0035063
Oct. 14, 2021 (KR) 10-2021-0136787
Mar. 18, 2022 (KR) 10-2022-0033776

(51) Int. Cl. G06Q 20/06; G06Q 40/04

(52) U.S. Cl. CPC G06Q 20/0655; G06Q 40/04; G06Q 2220/00

(57) ABSTRACT

The present invention relates to: a method for providing a digital currency platform service premised on an environment in which digital currency, including a central bank digital currency (CBDC), can freely circulate; and a system for same. Specifically, the present invention relates to providing a trading environment so that users can use various financial services by using digital currency, and relates to: a method for providing a platform service for supporting users so that the users can experience better convenience and security when using digital currency; and a system for same.

### CROSS-REFERENCE TO RELATED APPLICATION

This application is a Continuation of International Application No. PCT/KR2022/003806 filed on Mar. 18, 2022, which claims benefit of priority to Korean Patent Application No. 10-2021-0035063 filed on Mar. 18, 2021, No. 10-2021-0136787 filed on Oct. 14, 2021 and No. 10-2022-0033776 filed on Mar. 18, 2022, the entire content of which are incorporated herein by reference.

### TECHNICAL FIELD

The present invention relates to a method of providing a digital currency platform service and a system therefor on the assumption of an environment in which digital currency including Central Bank Digital Currency (CBDC) can be used. Specifically, the present invention relates to providing a transaction environment so that users may use various financial services using digital currency, and relates to a platform service providing method that supports users to enhance convenience and security when they use digital currency, and a system therefor.

### BACKGROUND ART

With the advancement in technology, digitalization is also accelerated in all areas of our lives. The progress of digitization is taking place in all areas regardless of real economy or monetary economy, and emergence of cryptocurrencies such as Bitcoin, emergence of simple payment using smartphones, and emergence of electronic wallets that can contain various personal credit card information and ID information are fragmentary examples showing that digitalization is progressing rapidly throughout the economy around our lives.

Meanwhile, each country is also preparing for digitalization works especially in monetary economy, and digital currency of central bank, i.e., the so-called Central Bank Digital Currency (CBDC), is already operating in China as a pilot project. At a time when an era of full-fledged central bank digital currency is approaching, granting rights to a platform capable of trading central bank digital currency of each country is proposed in this specification. Among them, particularly, the present invention proposes a method and system that can support transactions in association with digital currency, i.e., CBDC, when a user desires to make a trade in the capital market or trade securities.

The present invention is derived in view of the problems, and it is invented to solve the technical problems described above, and also provide additional technical elements that cannot be easily invented by those skilled in the art.

### DISCLOSURE OF INVENTION

### Technical Problem

An object of the present invention is to provide an environment in which central bank digital currency of each country can be traded through a platform service.

Particularly, the object of the present invention is to provide a platform service that allows overall management of a transaction process between a financial system and a central bank, when a central bank digital currency issued by a specific country is stored in an electronic wallet opened for each user, and the central bank digital currency is allowed to be used in the financial world of capital markets (securities), banks, loans (credit card), and insurances.

In addition, another object of the present invention is to provide an environment in which a user may use both digital currencies and traditional currencies when the user desires to make a trade in the capital markets, i.e., to trade securities.

In addition, another object of the present invention is to provide a transaction environment that allows users to enjoy various convenient functions in using central bank digital currencies like cash.

On the other hand, the technical problems of the present invention are not limited to the technical problems mentioned above, and unmentioned other technical problems will be clearly understood by those skilled in the art from the following description.

### Technical Solution

To accomplish the above objects, according to one aspect of the present invention, there is provided a method of providing a digital currency platform service by a digital currency platform server, the method comprising the steps of: receiving inputs for joining a digital currency service from a user terminal; interconnecting to a specific stock brokerage firm system by a user of the user terminal on the basis of the inputs received from the user terminal; receiving an input of financial transaction menu selection from the user terminal; receiving an input of a digital currency amount for a financial transaction from the user terminal; performing a financial transaction of digital currency on the basis of the input of financial transaction menu selection and the input of the amount; and generating transaction details according to performing the financial transaction, and distributing the transaction details to a blockchain network, wherein the digital currency is a Central Bank Digital Currency (CBDC).

In addition, in the method of providing a digital currency platform service, the transaction details distributed to the blockchain network include at least a user name, a stock brokerage firm bank account number, a digital currency platform service bank account number of the user opened through the digital currency platform server, a change in the digital currency according to performing the financial transaction, and a type of the financial transaction.

On the other hand, according to another aspect of the present invention, there is provided a method of providing a digital currency platform service by a digital currency platform server, the method comprising the steps of: receiving a request for an arbitrary transaction service from a user terminal of an arbitrary user; receiving digital currency—the digital currency is stored in an electronic wallet uniquely assigned to the user—from the user terminal; and calculating a value of the received digital currency on the basis of spot currency according to a predetermined ratio.

In addition, the method of providing a digital currency platform service may further comprise the step of transferring spot currency as much as the calculated value to a trading institution server, and at this point, the digital currency received from the user terminal is received after an approval procedure for approving change of ownership of the digital currency is executed by a specific approval authority.

### Advantageous Effects

According to the present invention, there is an effect of constructing an environment in which central bank digital currency of each country can be smoothly used throughout the financial and economic fields. Particularly, according to the present invention, there is an effect in that computer-based conversion or transaction is allowed so that the central bank digital currency of each country can be used in the systems of financial institutions of capital markets, banks, loans, or insurances.

In addition, according to the present invention, as a procedure of approving transfer of ownership of digital currency by an approval authority is included in making a financial transaction involving digital currency, there is an effect of decentralizing the functions of the central bank and making financial transactions more securely using the digital currency.

In addition, according to the present invention, as the value of digital currency is computed and calculated on the basis of the value of spot currency, there is an effect of stabilizing the value of digital currency, preventing users from simply using the digital currency as speculative assets or for speculative activities, and therefore contributing to allowing the digital currency to be used in the market in harmony with traditional currency.

In addition, according to the present invention, there is an effect of allowing a user to make a transaction through the digital currency even in an offline environment where the Internet is not connected.

On the other hand, the effects of the present invention are not limited to those mentioned above, and other unmentioned technical effects will be clearly understood by those skilled in the art from the description below.

### BRIEF DESCRIPTION OF THE DRAWINGS

FIG. 1 is a simplified view showing the overall system required to provide digital currency platform services.

FIG. 2 is a view for explaining the role of a digital currency platform server between a plurality of stock brokerage firms and a central bank.

FIG. 3 is a view for explaining in more detail the functions provided through the digital currency platform service.

FIG. 4 is a flowchart illustrating the process of receiving a digital currency platform service from the viewpoint of an individual user in order.

FIGS. 5 and 6 are views showing an embodiment of a transaction table in a common ledger managed by a digital currency platform server.

FIG. 7 is a view showing a sequence of processes in which an individual user possessing central bank digital currency trades stocks in a stock exchange.

FIG. 8 is a sequence diagram showing another embodiment of a method of providing a digital currency platform service according to the present invention, which shows a method of providing a digital currency platform service including a process of acquiring approval from an approval authority in a transaction.

FIG. 9 is a sequence diagram showing another embodiment, which is a view showing a digital currency transaction process using a payment code.

FIG. 10 is a sequence diagram showing another embodiment, which is a view showing in detail a digital currency charging process using a charge code.

FIG. 11 is a sequence diagram showing another embodiment, which is a view showing a method of providing a smart contract brokerage service.

FIG. 12 is a sequence diagram showing another embodiment, which is a view for explaining a function of monitoring a transaction among digital currency platform services.

FIG. 13 is a view showing another embodiment modified from the embodiment in FIG. 8.

### BEST MODE FOR CARRYING OUT THE INVENTION

Details of the objects and technical configurations of the present invention and operational effects according thereto will be more clearly understood by the following detailed description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

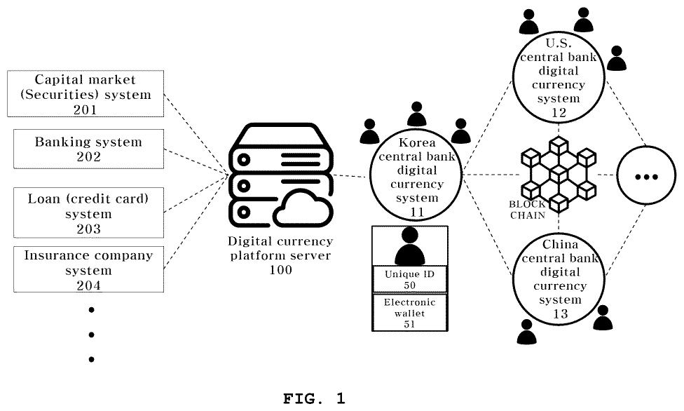

FIG. 1 is a view for helping users to briefly understand a digital currency platform service according to the present invention, and the digital currency platform service may be provided on the basis of a digital currency platform server 100. Referring to the drawing, it can be confirmed that the digital currency platform server 100 may be connected to central bank digital currency systems 11, 12, and 13, i.e., central bank digital currency systems that issue and/or manage CBDC, through a network, and also connected to financial systems such as a capital market (securities) system 201, a banking system 202, a loan (credit card) system 203, and an insurance company system 204 through a network. That is, the digital currency platform server 100 according to the present invention may exist between the central bank digital currency system 11 and systems that provide financial services, and the digital currency platform server 100 may perform a transaction process, an exchange process, or a distribution process for actual use of the digital currency between them. At this point, the term ‘process’ may include a process of simply relaying digital currencies, i.e., data packets having specific information or bundles of the packets, from one system to another, and also include all types of data processing that may exist in the procedure. That is, the digital currency platform server 100 may transfer information needed for trading, exchanging, or circulating digital currencies transmitted and received between two systems as it is, or perform data processing such as adding, removing, or substituting some of the information.

Meanwhile, the digital currency systems 11, 12, and 13 in the drawing may be actually implemented as at least one server computer, and at this point, the server computer may be an arithmetic device equipped with a central processing unit and a memory. The central processing unit may also be referred to as a controller, a microcontroller, a microprocessor, a microcomputer, or the like. In addition, the central processing unit may be implemented by hardware, firmware, software, or a combination of these, and when the central processing unit is implemented using hardware, it may be configured of application specific integrated circuits (ASIC), digital signal processors (DSP), digital signal processing devices (DSPD), programmable logic devices (PLD), field programmable gate arrays (FPGA), and the like, and when it is implemented using firmware or software, the firmware or software may be configured to include modules, procedures, functions, or the like that perform the functions or operations described above. In addition, the memory may be implemented as read only memory (ROM), random access memory (RAM), erasable programmable read only memory (EPROM), electrically erasable programmable read-only memory (EEPROM), flash memory, static RAM (SRAM), a hard disk drive (HDD), solid state drive (SSD), or the like.

On the other hand, the digital currency systems 11, 12, 13 may not be necessarily in the form of a server computer, and may take the form of a cloud server, i.e., a cloud server managed and operated by another operator.

Seeing the digital currency systems 11, 12, and 13 from the functional aspect, the digital currency system 11, 12, or 13 of each country may assign a unique identifier (unique ID) 50 to each user and assign an electronic wallet 51 to each user in addition. The unique identifier 50 is a means for distinguishing a user who desires to use digital currency, and may be configured of letters, numbers, or a combination of the letters and numbers. The electronic wallet 51 may be understood as a kind of account for recording the amount of digital currency that an individual possesses, the time of consuming or acquiring the digital currency, and the like.

In addition, the central bank digital currency of each country may be traded between the digital currency systems 11, 12, and 13 through a blockchain network, and the digital currency platform server 100 according to the present invention may also trade, exchange, and circulate the digital currency using the blockchain network.

For reference, the digital currency, the electronic wallet, and the relationship between the two mentioned in the detailed description will be described briefly. Unlike the traditional currency used offline, the digital currency may be understood as intangible currency stored or displayed on a user terminal (e.g., smartphone or the like) and used on/offline. Currently, the digital currency may be largely divided into virtual currency, cryptocurrency, stable coin, and central bank digital currency (CBDC) according to an issuing subject, management and supervision method, whether or not anonymity is guaranteed, value fluctuation, and the like, and the digital currency referred in this detailed description is preferably a central bank digital currency (CBDC), i.e., a kind of digital cash issued by a central bank on the basis of blockchain technology.

The electronic wallet service is a service that manages and presides payment of a user, including card information used for payment on the user terminal, bank account information of the user, and all information needed for making a payment for membership cards or coupons that provide payment benefits, and this is a service that allows a user to purchase goods or services anytime and anywhere through an electronic wallet created and assigned for each individual user.

In addition, for reference, the blockchain refers to a distributed data storage technique for connecting blocks that record transaction information of a predetermined period in the form of a chain and copying and storing the blocks on numerous computers simultaneously. The blockchain network is a data storage technique of a P2P structure that connects data like a chain in this way and discloses the data to anyone to view without storing transaction records in a centralized server so that data forgery or alteration may not be made fundamentally, i.e., all the people may monitor the transaction records.

The data recorded in the blockchain is characterized in that anyone may trust the data since forgery and alteration through hacking is very difficult, and in addition, since the data recorded in the blockchain is stored in a plurality of computers in a distributed manner, it is safe from DDoS attacks or ransomware attacks made on a specific node. Furthermore, since the blockchain can be maintained and operated autonomously by equal participants, it is more flexible compared to existing server-client structures in which all information is concentrated in a central server.

The blockchain technique may be used in various fields such as cryptocurrency, smart contract, logistics management, document management, identity verification, and the like, and it should be noted that the blockchain technique may be used for smart contracts in relation to the digital currency platform server 100 according to the present invention. The smart contract is a function that automatically executes the content of a contract when a predetermined condition is satisfied, which is a digital electronic contract function that allows a user to conclude a desired contract on the basis of P2P without having a third guarantee company in the middle.

Such a smart contract may be applied as is to the digital currency platform server 100 according to the present invention, and naturally, it is assumed that transactions based on such a smart contract are made on a blockchain network.

Referring to FIG. 1 again, it has been explained that the digital currency platform server 100 may also be linked to systems that provide other financial services through a network, and the financial services may also be implemented in a server computer(s) equipped with a central processing unit and a memory in a way similar to the digital currency systems 11, 12, and 13 of each country described above.

On the other hand, the digital currency platform server 100 is not necessarily limited to be connected to only a server computer through a network, and may be connected to a so-called user terminal so that the service may be provided to general individual users. The user terminal refers to a terminal possessed or carried by a user, and may include portable terminals such as a smartphone, PDA, and tablet PC, as well as installation-type terminals such as a home PC and the like. Seeing these user terminals from the viewpoint of a device, it is assumed that each user terminal has a central processing unit (CPU) and a memory.

The user terminal may include a display and a touch-sensitive surface, and may additionally be connected with one or more other physical user input means, such as a physical keyboard, mouse, and/or joystick. In addition, the user terminal may further include a means for sensing and recording sounds or voices. Meanwhile, various applications executed on the user terminal may optionally use at least one universal means for physical user input, such as a touch-sensitive surface. One or more functions of the touch-sensitive surface, as well as corresponding information displayed on the user terminal, may optionally be adjusted and/or changed from one application to a next application and/or within individual applications. In this way, a universal physical architecture (such as the touch-sensitive surface) of the user terminal may support various applications as an option using user interfaces that are intuitive and clear to the user.

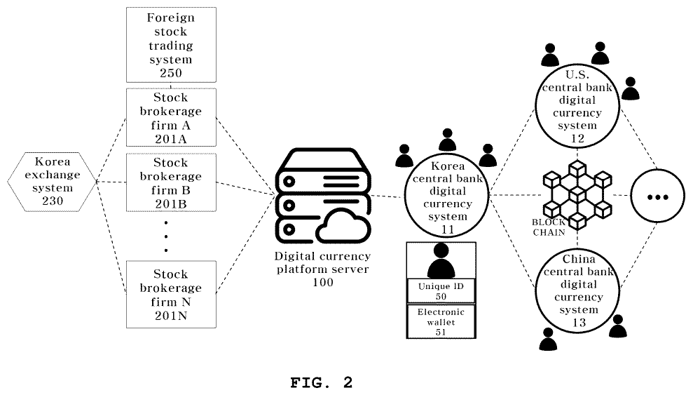

FIG. 2 shows a view of connecting a number of stock brokerage firm systems 201A to 201N to the digital currency platform server 100 according to the present invention through a network, and a view of interconnecting stock brokerage firm systems 201A to 201N to the Korea exchange system 230 that manages stock trading or a foreign stock trading system 250 for overseas stock trading. As it can be confirmed again in FIG. 2, the digital currency platform server 100 performs a function of processing and transferring digital currency from the central bank digital currency systems 11, 12, and 13 in a form that can be used in the capital market in response to a request of a user having a unique ID 50 and digital currency (CBDC) in the electronic wallet 51, and allowing the digital currency processed in this way to be smoothly consumed on other trading institutions or other trading systems. Understanding FIG. 2 from another aspect, it can be understood that the digital currency platform server 100 performs a function of allowing digital currency issued by the central bank digital currency systems 11, 12, and 13, i.e., digital currency possessed by an individual user in the electronic wallet 51, to be used for transactions in the capital market through the stock brokerage firm systems 201A to 201N.

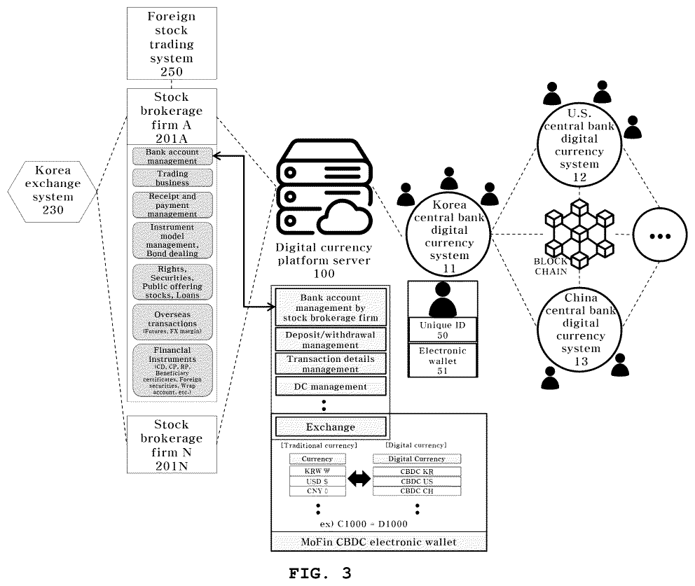

FIG. 3 is a view for looking into an actual implementation example in more detail, and here, tasks that can be performed in the digital currency platform server 100 are listed. Seeing the drawing, the digital currency platform server 100 according to the present invention may perform a bank account management task for each stock brokerage firm, a deposit/withdrawal management task, a transaction details management task, a digital currency management task, an exchange task, and the like. In relation to the bank account management task for each stock brokerage firm, the digital currency platform server 100 may be connected to a plurality of stock brokerage firm systems, and particularly, it may inquire bank account information opened in each stock brokerage firm, or make a deposit or a withdrawal on the bank account. The user may attempt a financial transaction using digital currency in an environment connected to a plurality of stock brokerage firm systems simply by joining a service provided by the digital currency platform server 100.

In relation to the deposit/withdrawal management task, the digital currency platform server 100 may internally generate and manage individual accounts or individual bank accounts of a user, and may support deposit and withdrawal of digital currency of the user. For example, the user may store some of his or her digital currency through the digital currency platform server 100, and a compensation (interest) may be paid for the stored digital currency according to at least one among the storage amount or storage period. In addition, the user may withdraw the digital currency from a bank account existing in the digital currency platform server 100 to his/her user terminal. For reference, the user may prevent theft of the digital currency in advance by storing the digital currency in the individual account or individual bank account managed by the digital currency platform server 100, and may also prevent a risk of loss of the digital currency that may occur due to loss or theft of the user terminal. On the other hand, the digital currency stored in the digital currency platform server 100 may be also used when the digital currency platform server 100 provides other financial services and other financial instruments to other users, and in some cases, a predetermined compensation may be given to the original owner who stores the digital currency.

In relation to the transaction details management task, the digital currency platform server 100 may record all the details of transactions made by the user through the digital currency platform server 100, and particularly, additional information related to each transaction, such as an amount of digital currency used for a transaction, transaction time, transaction date, transaction counterpart, transaction usage, success or failure of transaction, transaction purpose, and the like, may be recorded together. On the other hand, although information on the transaction details may be stored in the digital currency platform server 100 itself, more preferably, the transaction details may be distributed on the blockchain so that information on the transaction details of individual users may be prevented from being manipulated without permission or lost.

In relation to the digital currency management task, it is natural that a large amount of digital currency is processed since the nature of the digital currency platform server 100 is to support a financial transaction environment in which digital currency is utilized, and at this point, the digital currency platform server 100 itself may perform a function of maintaining or managing errors of a large amount of digital currency being processed. The digital currency may exist in the form of specific data having a software property of being transmitted between devices, and there may be occasions in which the process is difficult as an error occurs or the capacity increases in the process of utilizing the currency in financial transactions. The digital currency platform server 100 may monitor whether abnormal digital currency exists, and maintain the quality of digital currency used in the market to a predetermined level by discarding the abnormal digital currency or restoring/improving the error as needed. Although additional procedures, e.g., an approval procedure of the central bank digital currency systems 11, 12, and 13 or an approval procedure of individual users, may be further required in the process of discarding and restoring/improving the digital currency, the digital currency platform server 100 may perform management tasks for the digital currency on the assumption that all of these procedures are approved and completed.

In relation to the exchange task, the exchange task may include exchange between existing spot currency and digital (electronic) currency (exchange between Korean Won (KRW) unit currency and Korean digital currency, or between KRW unit currency and US digital currency, etc.), or exchange between central bank digital currency of individual countries (exchange between Korean digital currency and US digital currency, or between US digital currency and Chinese digital currency, etc.). In addition, for reference, although it will be described on the assumption that the exchange between the spot currency and the digital (electronic) currency is made at a ratio of 1:1 in the digital currency platform server 100 according to the present invention, it is understood that this is arbitrarily set to help understanding of the present invention, and the exchange rate may vary. In addition, for reference, although the term ‘exchange’ is also used for trading between the traditional currency and the digital currency in this detailed description, it is understood that the term ‘change’ may be used instead for trading between the traditional currency and the digital currency or trading between digital currency and digital currency.

In addition, in addition to the tasks mentioned above, various tasks related to transaction behaviors accompanied with digital currency (CBDC) may be performed by the digital currency platform server 100.

On the other hand, tasks that can be processed by the stock brokerage firm systems are also listed in FIG. 3 for reference, and seeing the drawing, the stock brokerage firm system (expressed as stock brokerage firm A in the drawing) may perform bank account management, trading business, receipt and payment management, instrument model management and bond dealing, rights, securities, public offering stocks, loans, overseas trading, financial instruments, and the like. In addition, each stock brokerage firm system is connected to the digital currency platform server 100 as needed through a network, and may approve financial transactions and perform transactions in response to a financial transaction request (e.g., request for deposit, withdrawal, or the like) from the digital currency platform server 100.

Meanwhile, briefly describing a method of providing a digital currency platform service by the digital currency platform server according to the present invention, the method includes the steps of: receiving inputs for joining a digital currency service from a user terminal; interconnecting to a specific stock brokerage firm system by a user of the user terminal on the basis of the inputs received from the user terminal; receiving an input of financial transaction menu selection from the user terminal; receiving an input of a digital currency amount for a financial transaction from the user terminal; performing a financial transaction of digital currency on the basis of the input of financial transaction menu selection and the input of the amount; and generating transaction details according to performing the financial transaction, and distributing the transaction details to a blockchain network, and the digital currency may be the Central Bank Digital Currency (CBDC). At this point, the financial transaction may include all types of financial transactions accompanied with digital currency.

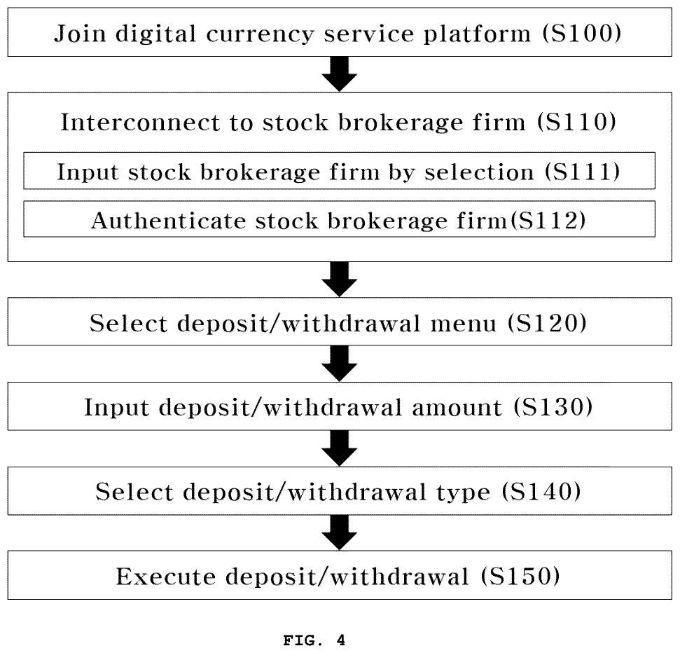

FIG. 4 is a view explaining in detail the process of using the digital currency platform service from the viewpoint of a user, and more accurately, for finding out through which steps the stock brokerage firm bank account management function provided by the digital currency platform server 100 is accomplished. For reference, a situation is assumed, in which a user in this embodiment has digital currency issued by the Korea Central Bank digital currency system 11 or an institution corresponding thereto in the electronic wallet, and uses the service while possessing his or her user terminal (smartphone).

Referring to FIG. 4, first of all, the digital currency platform server 100 performs a step of receiving needed information from a user terminal and registering the user as a member (S100). This step may be accompanied with a user authentication process, and at the member joining step including the user authentication process, a name, a resident registration number, an address, or other information for identifying an individual may be requested.

Next, a step of connecting to a stock brokerage firm (S110) may be performed. This step is a step of networking in response to a request of a user so that the digital currency platform server 100 may be connected to a specific stock brokerage firm system, and may include steps of receiving an input of selecting a stock brokerage firm from a user terminal (S111), and receiving authentication from the stock brokerage firm (S112).

When steps S100 and S110 are regarded as preliminary steps for full-scale use of the service, the steps from step S120 may be regarded as steps in which a user actually uses the service.

Step S120 is a step of receiving an input of a deposit/withdrawal menu from the user (S120). As described above, the digital currency platform server 100 may provide the user with services related to various tasks, and this embodiment relates to using a service for depositing and withdrawing digital currency among the tasks in connection with a stock brokerage firm bank account. Seeing this step from the viewpoint of user's experience, the user may execute this step in a way of executing and logging in an application (e.g., mobile CBDC platform app or web) installed in his/her user terminal (smartphone) or PC, and then selecting the ‘Bank Account Deposit/Withdrawal’ item from the menu displayed on the user terminal.

Thereafter, a step of inputting a deposit/withdrawal amount (S130) and a step of selecting a deposit/withdrawal type (S140) are performed, and after all the selection inputs by the user are completed, a step of executing deposit/withdrawal in connection with the stock brokerage firm system (S150) may be performed by the digital currency platform server 100.

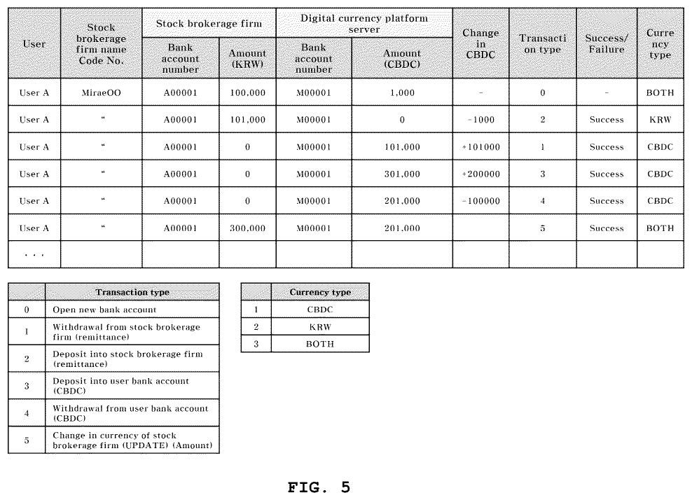

FIG. 5 shows an example of a transaction table in a common ledger managed by the digital currency platform server 100. The digital currency platform server 100 records transaction details of the user, and may record the transaction details in the form of a transaction table as shown in FIG. 5, and this transaction table may be distributed and stored on a blockchain network. For reference, in this detailed description, the ‘ledger’ is distributed on the blockchain network by the digital currency platform server 100, and records trades (transactions) through the digital currency platform server 100, and the transaction table of FIG. 5 may be the ledger itself or part of data constituting the ledger.

Referring to FIG. 5 again, the transaction table may necessarily include a user, a stock brokerage firm name, a stock brokerage firm bank account number and an amount, and a digital currency platform service bank account number (hereinafter, abbreviated as a service bank account number) and an amount, and may further include items such as a change in the amount, a transaction type, success or failure of transaction, a currency type, and the like. In the transaction table of FIG. 5, user A's history of using the digital currency platform service linked to a stock brokerage firm called Mirae OO is described. Starting from the topmost transaction in order, a first transaction is the record of a transaction in which user A newly opens a stock brokerage firm bank account or a digital currency platform service bank account (hereinafter, abbreviated as a service bank account), and it can be seen that it is a transaction of opening a new bank account with a deposit of 100,000 KRW in the stock brokerage firm bank account and a deposit of 1,000 CBDC in the service bank account initially. A second transaction relates to a transaction in which user A makes a deposit into the stock brokerage firm bank account, and it can be seen that as 1,000 CBDC is transferred from the service bank account to the stock brokerage firm bank account, the balance of the stock brokerage firm bank account becomes 101,000 KRW. For reference, although it is explained in this embodiment on the assumption that the value ratio between the KRW and the CBDC is 1:1, it should be understood that this ratio may vary, and in addition, it should be understood that the currency value is calculated by applying a value ratio suitable for each case when depositing and withdrawing the currency. A third transaction relates to a transaction in which a withdrawal is made from the stock brokerage firm bank account to the service bank account, and it can be seen that as 101,000 KRW is transferred from the stock brokerage firm bank account to the service bank account, the balance of the service bank account becomes 101,000 CBDC. A fourth transaction relates to a transaction in which user A himself or herself deposits 200,000 CBDC of digital currency into the service bank account, and it can be seen that the balance of the service bank account becomes 301,000 CBDC through this transaction. A fifth transaction relates to a transaction in which user A withdraws 100,000 CBDC of digital currency from the service bank account, and it can be seen that the balance of the service bank account becomes 201,000 CBDC through this transaction. Finally, a sixth transaction relates to updating the balance of the stock brokerage firm bank account, and the balance of the stock brokerage firm bank account may vary according to the performance of the stock brokerage firm, and the digital currency platform server 100 may update the balance of the stock brokerage firm bank account and record the balance in the transaction table by inquiring the brokerage bank account as needed or periodically.

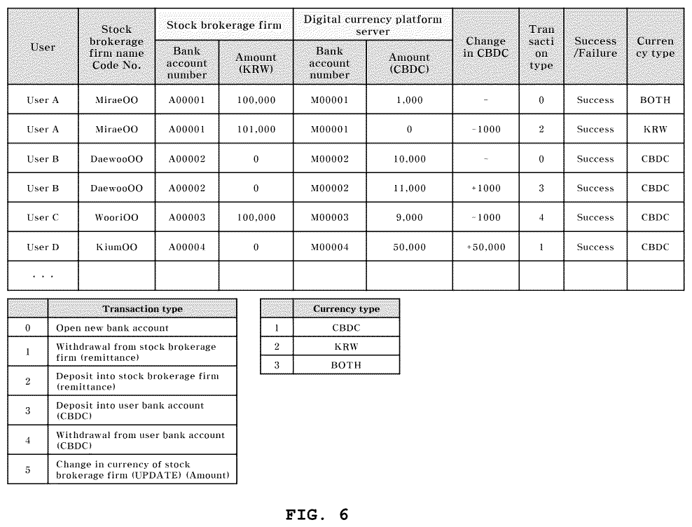

FIG. 6 is also an example of a transaction table managed by the digital currency platform server 100. The difference from the example of the transaction table shown in FIG. 5 is that the transaction table in FIG. 5 records only transaction details of user A, whereas the transaction table in FIG. 6 records transaction details of a plurality of users together. In this way, the digital currency platform server 100 may record a transaction table dedicated to one user and share the table on the blockchain network, or record a common transaction table for a plurality of users and share the table on the blockchain network. Referring to FIG. 6, since the first transaction and the second transaction of user A relate to opening of a bank account and withdrawal from the stock brokerage firm bank account and they are the same as shown in FIG. 5, detailed descriptions thereof will be omitted. On the other hand, user B's first transaction is made in association with another stock brokerage firm system, and this relates to a transaction in which user B opens a service bank account while initially depositing 10,000 CBDC into the service bank account. In addition, user B's second transaction relates to depositing 1,000 CBDC into the service bank account by user B, and it can be seen that the service bank account (M00002) has a balance of 11,000 CBDC. In addition, user C's first transaction records a situation in which user C withdraws from the service bank account (M00003) and the service bank account has a balance of 9,000 CBDC. In addition, user D's first transaction is a transaction with another stock brokerage firm system, and this records a situation in which user D withdraws 50,000 KRW from the stock brokerage firm bank account (A00004) and the balance of the service bank account (M00004) becomes 50,000 CBDC.

In this way, the digital currency platform server 100 may record transaction details of using digital currency, and distribute and store the transaction table or a ledger including the transaction table on the blockchain network.

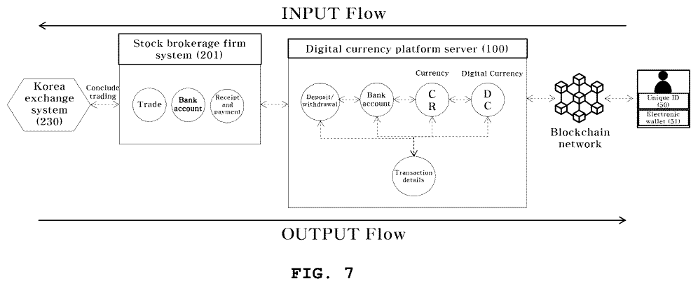

FIG. 7 shows a case in which a certain individual trades stocks with his or her digital currency (CBDC) by utilizing the digital currency platform server 100, and the process will be described in order with reference to FIG. 7.

This process first starts from the step of transferring digital currency (CBDC) stored in the electronic wallet 51 to the digital currency platform server 100 through the blockchain network in response to a request of a user assigned with a random unique ID 50 and an electronic wallet 51. For reference, the digital currency platform server 100 according to the present invention may assign the unique ID 50 or a separate identifier mapped to the electronic wallet 51 to each user. For example, even the digital currency platform server 100 may define and assign an identifier one-to-one mapped to the unique ID 50 by inserting alphabetic letter “m” in front of the unique ID 50 of the user.

On the other hand, the value of the digital currency received from the digital currency platform server 100 is calculated based on the amount of spot currency according to a predetermined ratio, and spot currency equivalent to the value may be deposited into the user's bank account.

The spot currency deposited in this way may be deposited into and withdrawn from the stock brokerage firm bank account in association with the stock brokerage firm system 201, and the spot currency deposited into the stock brokerage firm bank account may be used for trading stocks at the Korea Exchange 230.

In this process, particularly, all the processes of of the data processing carried out in the digital currency platform server 100 may remain as transaction detail data, and these transaction details are shared with a plurality of participants existing on the blockchain network to increase security.

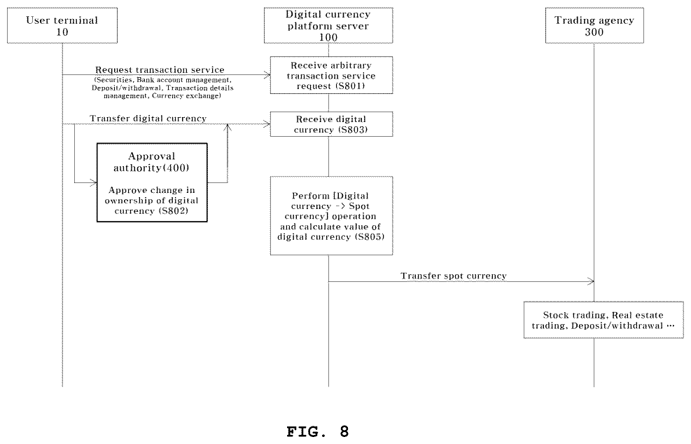

FIG. 8 shows another embodiment of a service provided by the digital currency platform server 100, which shows a method of providing a digital currency platform service including a process of acquiring approval from an approval authority when making a transaction.

Referring to FIG. 8, it is assumed that an application dedicated to the digital currency platform service or an electronic wallet application is previously installed in the user terminal 10 and used as a means for possessing, storing, and paying digital currency of the user. Meanwhile, in order to perform a monetary transaction such as trading of securities, account management, deposit/withdrawal transaction, transaction details management, currency exchange, or the like through the digital currency that the user possesses, first, the user may request a desired transaction service by selecting a desired monetary transaction from the digital currency platform server 100, and the digital currency platform server 100 may receive the request (S801).

For reference, FIG. 2 shows a process in which the digital currency platform server 100 supports a user to perform a service of trading securities through digital currency when the user selects trading of securities, and the securities at this point may include currency securities, commodity securities, equity securities, bearer securities, selective bearer securities, factor securities, and abstraktes Papier (securities for abstraction).

After step S801, the digital currency platform server 100 may receive digital currency from the user terminal 10. Here, the digital currency received from the user terminal 10 may be a currency of which change of ownership is approved by the approval authority 400 (S802) to improve reliability between the transaction parties and stability of the transaction. The approval authority 400 herein may be an institution that has issued the digital currency or has been entrusted by the issuing institution. For example, the approval authority 400 may be a central bank or a separate institution entrusted with the task of approving change of ownership from the central bank. The approval authority 400 may be an institution operated or managed by the central government, and performs a process of verifying the digital currency, i.e., whether it is a legitimate user's digital currency, whether it is illegally intervened digital currency, whether it is a counterfeit or a falsified digital currency, and the like, before approving change of ownership of the digital currency, by tracking currency flow of the digital currency of which the ownership is to be changed.

Meanwhile, the approval authority 400 may verify the digital currency in cooperation with commercial banks to verify the digital currency, and the commercial banks that verify the digital currency in cooperation with the approval authority 400 may be granted with the right to change the ownership of the digital currency as much as a predetermined quota as a kind of reward. However, when a commercial bank changes the ownership of digital currency, it needs to be continuously managed and supervised by the approval authority 400. In addition, when the right to approve the change of ownership of the digital currency is granted to the commercial bank, the functions of the approval authority 400 may be distributed in a way of approving change of ownership of the digital currency by the commercial bank when the transaction amount is smaller than a predetermined amount and approving change of ownership of the digital currency by the central bank itself when the transaction amount exceeds the predetermined amount.

Referring to FIG. 8 again, when the approval authority 400 has approved the change of ownership of the digital currency in the process of transferring the digital currency to the digital currency platform server 100 by the user terminal 10, the digital currency platform server 100 may finally receive the digital currency of which the ownership is changed (S803).

When the digital currency of which the ownership is changed is received, the digital currency platform server 100 may calculate the value of the digital currency on the basis of spot currency according to a predetermined ratio (S805). At this point, the predetermined ratio may vary according to the type of securities, and for example, the digital currency and legal currency (conventional paper currency) may have a ratio of 1:1, and a ratio agreed between a creditor and a debtor when the contract is concluded may be the predetermined ratio in the case of a bond of capital securities, and a ratio agreed between a shipper and a carrier when a bill of consignment of commodity securities is issued may be the predetermined ratio in the case of a bill of consignment.

After the digital currency platform server 100 calculates the value of the digital currency on the basis of spot currency according to a predetermined ratio, as the spot currency is transferred to an institution that proceeds a transaction with the user, i.e., a trading institution 300, the digital currency transaction between the user and the trading institution 300 is completed.

For reference, the embodiment shown in FIG. 8 may be applied even in trading securities through digital currency, in other words, when security token offerings (STOs) are used as a medium of trading. The security tokens offering may be tokenizing various real assets such as stocks, bonds, real estate, and artworks, and selling them like stocks, and when the security token offerings (STOs) are used, the profits may be shared with others, and the liquidity problem of cash can be solved. On the other hand, as the security token offerings (STOs) have been traded mainly by private companies or stock brokerage firms so far without special intervention of the central government, it does not attract public attention since the security token offerings (STOs) have not yet been clearly defined and utilization thereof is not ensured. However, when the present invention is utilized, the problem of ambiguity can be solved as there is a process of approving also the security token offerings in the middle, and as a result, there is an effect of enhancing stability and reliability in trading digital currencies, and improving versatility of the security token offerings (STOs).

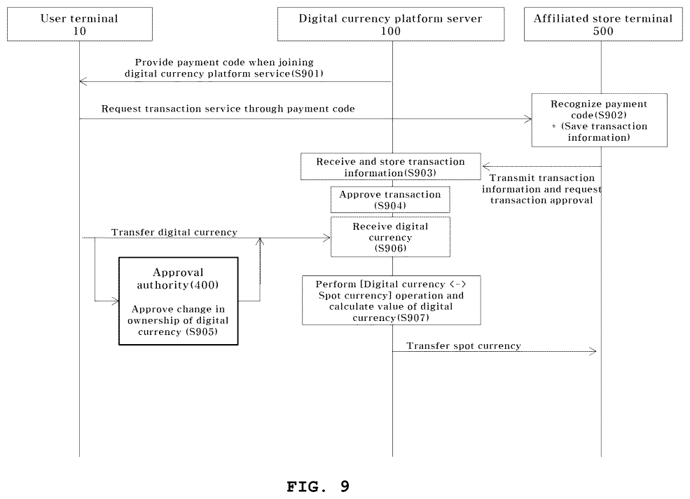

FIG. 9 is a sequence diagram showing another embodiment, which is a view showing a digital currency transaction process using a payment code.

The method of providing a digital currency platform service according to FIG. 9 is a method that enables financial transactions using digital currency as a medium in an offline environment, as well as in an online environment, which is a payment method that induces a user to receive a payment code from the digital currency platform server 100 and utilize the payment code to conveniently make digital currency transactions anytime and anywhere without online or offline restrictions. For example, when it is assumed that although a user who has stored digital currency in the user terminal 10 desires to buy goods at a convenience store using the digital currency, and the user terminal 10 is disconnected from the Internet, the digital currency transaction can be made as the user presents the payment code provided when the digital currency platform server 100 joins the service to the convenience store, and the convenience store recognizes the payment code.

The payment code at this point is a code that includes a series of information related to the payment, such as a barcode or a QR code, and may be provided when the user joins the digital currency platform service. Although the payment code is a code unique to a user, which identifies the user in making a transaction using the digital currency, a service may be provided to update the payment code of the user after a predetermined period of time in order to prevent other users not to steal the payment code and acquire unfair profits.

Meanwhile, a code recognizer for recognizing the payment code will be required in order to recognize the payment code of the user, and generally, the code recognizer may be provided in an affiliated store that has joined the digital currency platform service. The code recognizer may be a barcode recognizer or a QR code recognizer, and these means may be connected to the affiliated store terminal 500. Furthermore, considering that digital currency transactions may be conducted between users, not affiliated stores, the payment code may also be recognized through a camera provided in the user terminal 10.

According to FIG. 9, the digital currency transaction service using the payment code begins when the digital currency platform server 100 provides a payment code to a user who has joined the digital currency platform service (S901).

Thereafter, the user may request a transaction by presenting the payment code to the affiliated store terminal 500, and at this point, the affiliated store terminal 500 recognizes the payment code through a means that can recognize the code (S902).

Subsequently, the affiliated store terminal 500 may transmit transaction information to the digital currency platform server 100 and request approval of the transaction, and the digital currency platform server 100 may receive and store the transaction information (S903). At this point, the transaction information may include information that can be generated by the transaction between the user and the affiliated store terminal 500, such as the names of the transaction parties, a transaction amount, a transaction date, a transaction time, and the like, which can identify individual transactions.

After step S903, the digital currency platform server 100 verifies whether the transaction is reasonable based on the transaction information and whether it is proper to approve the transaction, and approves the transaction when the verification is completed (S904).

After step S904, the digital currency platform server 100 may receive digital currency from the user terminal 10 through the process of approving change of ownership described in FIG. 8 (S905, S906). In addition, thereafter, the digital currency platform server 100 may calculate the value of the digital currency on the basis of spot currency according to a predetermined ratio and complete the transaction by transferring the spot currency to the affiliated store terminal 500 (S907).

The embodiment of FIG. 9 may be performed in a similar manner even when the networks between the user terminal 10, the digital currency platform server 100, and the affiliated store terminal 500 are all inoperable (offline situation). This may be accomplished in a way of matching transaction information to a payment code when the affiliated store terminal 500 recognizes the payment code from the user terminal 10 and separately storing the transaction information in the affiliated store terminal 500, and requesting payment from the digital currency platform server 100 when the network connection is restored later. That is, referring to FIG. 9, the affiliated store terminal 500 may recognize the payment code of the user terminal 10 in an offline state, and record corresponding transaction information by inputting and storing a product or service price by matching them with the payment code. On the other hand, although the affiliated store terminal 500 may not immediately receive a payment in spot currency when the network is inoperable, the affiliated store may charge the user for the transaction by providing goods or services to the user first and then transferring previously recorded transaction information to the digital currency platform server 100 thereafter. This may be applied to a transaction between users, i.e., a digital currency remittance between smartphones, as well as when the target of transaction using digital currency is the affiliated store terminal 500. For example, when the payment code shown on the display of a first smartphone is recognized at a place where a network environment is not provided at all as the payment code is captured using a camera of a second smartphone, and the amount of digital currency to be received is recorded while being matched with the payment code on an application installed in the second smartphone, the user of the second smartphone may receive the digital currency by transferring the previously recorded payment code and transaction information (the amount of digital currency to be received) to the digital currency platform server 100 when an environment in which the second smartphone may be connected to the network is established in the future.

Meanwhile, when the payment code and the transaction information are received thereafter, the digital currency platform server 100 may deduct the digital currency of the user deposited in advance and pay the digital currency appropriate for the transaction, or may make a digital currency payment to a user having a credit by requesting a user having a debt to transfer digital currency.

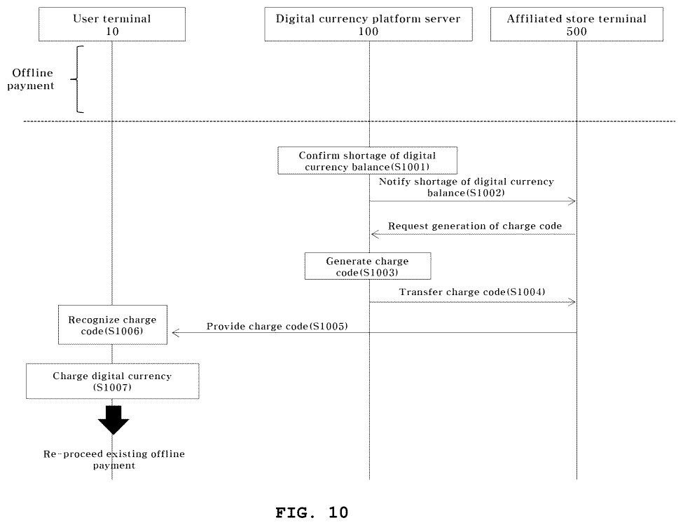

FIG. 10 is a sequence diagram showing another embodiment, which is a view showing in detail a digital currency charging process using a charge code.

The digital currency platform service shown in FIG. 10 relates to a process of generating and providing a charge code by the digital currency platform server 100, when a transaction is not proceeded any longer due to insufficient balance of digital currency in the user terminal 10 in the process of a digital currency transaction between the user and the affiliated store terminal 500, to induce the digital currency transaction to be proceeded by conveniently charging digital currency anytime and anywhere without online or offline restrictions using the charge code. As an easy example, it can be understood as a service in which when a transaction cannot be proceeded any longer as the user terminal 10 is disconnected from the Internet although a user who has deposited digital currency in the user terminal 10 tries to purchase a product at a convenience store through the digital currency or the balance of the digital currency deposited in the user terminal is insufficient although the user tries to proceed the transaction through a payment code, the digital currency platform server 100 generates a charge code and transfers the charge code to the affiliated store terminal 500, and the affiliated store terminal 500 presents the charge code to the user so that the user may recognize the charge code using the user terminal 10, charge digital currency, and proceed the transaction again with the charged digital currency.

Although the charge code at this point is a code that includes a series of information related to payment, such as a barcode and a QR code, like the payment code in FIG. 9, it is different from the payment code in that the information included in the code is information related to charging digital currency.

According to FIG. 10, this embodiment may start from the step of confirming that the digital currency balance in the user terminal 10 is insufficient by the digital currency platform server 100 (S1001). When it is confirmed that the digital currency balance is insufficient, the digital currency platform server 100 notifies the affiliated store terminal 500 that the digital currency balance in the user terminal 10 is insufficient (S1002).

Thereafter, the affiliated store terminal 500 may request the digital currency platform server 100 to generate a charge code in order to proceed the transaction again, and in response thereto, the digital currency platform server 100 may generate a charge code (S1003), and transfer the charge code to the affiliated store terminal 500 (S1004).

When the digital currency platform server 100 transfers the generated charge code to the trading institution 300, the trading institution provides the received charge code to the user. As described in the other embodiments, the method of providing the charge code will be a method of recognizing the charge code with a recognition means (e.g., camera) provided in the user terminal 10 when the charge code is output through a display means of the affiliated store terminal 500.

After recognizing the charge code, digital currency may be charged in the user terminal 10 (S1007), and offline payment proceeded before may be proceeded again using the charged digital currency.

Meanwhile, the charge code generated by the digital currency platform server 100 may function as a promissory note. Seeing the transaction process, it is configured as a structure in which when the digital currency balance of a user is insufficient and the affiliated store terminal 500 receives the charge code generated by the digital currency platform server 100 and the affiliated store terminal 500 presents the charge code to the user, the user recognizes the charge code through the user terminal 10 so that the transaction is approved immediately, and the digital currency platform server 100 recognizes the behavior of recognizing the charge code by the user terminal 10 as a behavior of promising to pay digital currency within a predetermined period of time, and as this may be considered as a structure in which the digital currency platform server 100 allows the user to pay digital currency within a predetermined period of time, and the transaction is cancelled when the user does not pay the digital currency within the predetermined period of time, the charge code may function like a promissory note as a result.

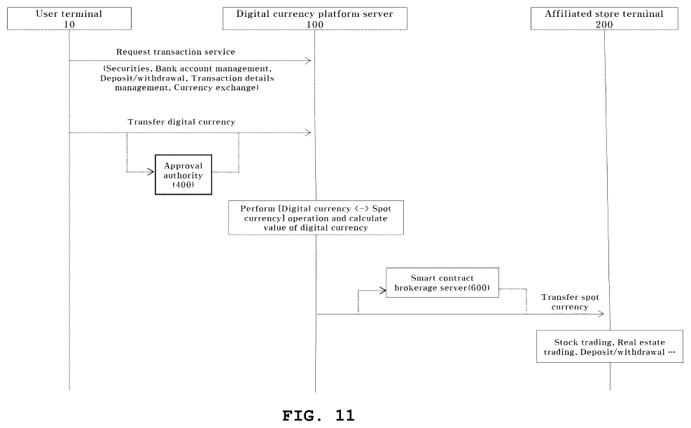

FIG. 11 is a sequence diagram showing another embodiment, which is a view showing a method of providing a smart contract brokerage service.

FIG. 11 relates to a so-called smart contract brokerage service in which the digital currency platform server 100 mediates contracts needed for trading securities, real estates, or the like of a user, matches a trading institution that satisfies the conditions desired by the user, keeps and stores contracts written when a contract is made, and provides follow-up services of confirming whether the conditions presented by the contractors are fulfilled well after the contract is concluded.

The smart contract brokerage server 600 shown in FIG. 11 may be another server that the digital currency platform server 100 may manage, and in simple terms, the smart contract brokerage server 600 may be a server that mediates contracts by intervening in signing a contract between an individual and an affiliated store terminal 500, signing a contract between an affiliated store terminal 500 and another affiliated store terminal, and signing a contract between individuals.

The smart contract brokerage server 600 provides a service for matching a user who joins the smart contract brokerage service with a trading institution that satisfies the desired conditions. As an easy example, when a first user desires to find a rental house of a condition corresponding to a deposit of A KRW or less and a rental deposit of B KRW or less, and the first user sets real estate trading in the smart contract brokerage service, and sets the condition of a deposit of A KRW or less and a rental deposit of B KRW or less, the smart contract brokerage service may match a trading institution 300 corresponding to the condition with a second user, or match the trading institution with an affiliated store or a second user corresponding to a condition similar to the above conditions although the trading institution does not correspond to the condition. For reference, an affiliated store or a user using the service will be of course an affiliated store or a user who has joined the digital currency platform server 100, and may utilize trading services other than the real estate trading mentioned above.

Meanwhile, the smart contract brokerage server 600 provides a service of keeping and storing a series of contract-related information, such as written contracts, certificates, and guarantees that may assert rights between contracting parties after the contract is concluded. In other words, the smart contract brokerage server 600 keeps and stores contract-related information on behalf of a user or an affiliated store to prevent a case where beginners in society not yet familiar with contract transactions, minor groups who need continuous management and protection in monetary transactions, or the like lose or damage the contract-related information by mistake after the contract is concluded. At this point, keeping and storing information may be a method of distributing the information on the blockchain network.

On the other hand, the smart contract brokerage server 600 may provide a follow-up service that manages on behalf of the contractors to confirm whether the contract conditions presented at the time of signing the contract are properly fulfilled even after the contract is concluded. As an easy example, when a first user and a second user who have joined the digital currency platform server 100 have concluded a contract through the smart contract brokerage server 600 on condition that the first user pays one million KRW per month to the second user for one year from the time of signing the contract, the smart contract brokerage server may provide a follow-up service of managing the contract even after the contract is concluded by confirming on behalf of the contractors whether the first user pays one million KRW per month to the second user for one year, and recording the confirmation.

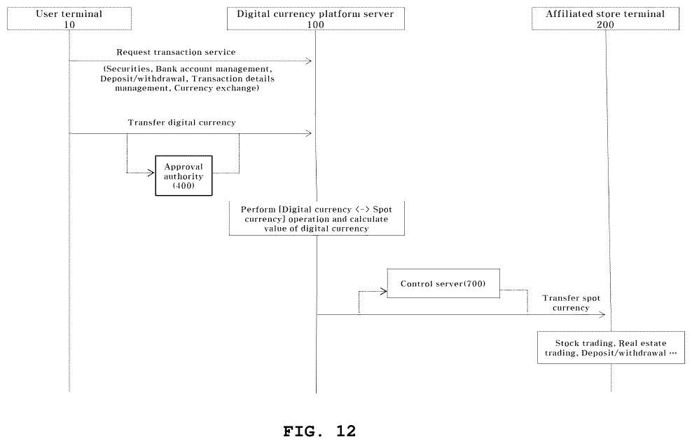

FIG. 12 is a sequence diagram showing another embodiment, which is a view for explaining a function of monitoring a transaction among digital currency platform services.

Like the smart contract brokerage server 600 described above, the digital currency platform server 100 may further operate a control server 700 for monitoring transactions in real time, storing transaction details when a transaction is concluded, and fundamentally blocking unfair monetary transactions and illegal behaviors.

The control server 700 according to FIG. 12 may be another server operated or managed by the digital currency platform server 100, and the control server 700 may be a server intervening in the middle of signing a contract between an individual and an affiliated store terminal 500, signing a contract between an affiliated store terminal 500 and another affiliated store terminal, and signing a contract between individuals, to detect users (swindlers) who have a history of attempting illegal behaviors in the middle of a contract and attempting illegal behaviors in the past, and block the contract before the contract is concluded.

Like the smart contract brokerage server 600 described above, the control server 700 may monitor transactions in real time to detect whether an illegal behavior for acquiring unfair profits is performed in the process of making a transaction.

In addition, the control server 700 may monitor the transaction process in real time and store transaction details of the concluded transaction when users conclude the transaction.

Meanwhile, when an illegal behavior or an attempt of illegal behavior is made in the process of making a transaction, the control server 700 may collect and store all the information about a special user who has performed an illegal behavior, such as information on the identity of the special user who has performed or attempted an illegal behavior, a GPS address where the behavior has been performed, the terminal of the special user, and Internet Protocol (IP) address of the special user, and the like.

In addition, when a special user, who has committed an illegal behavior or attempted an illegal behavior in the past based on the information on the stored transaction details and the special user, attempts a transaction, the control server 700 may detect and block the attempt of the transaction of the special user in order to prevent the special user from making a transaction or to protect a transaction counterpart who makes a transaction with the special user.

In this way, when beginners in society not yet familiar with contract transactions or minor groups who need continuous management and protection in monetary transactions make a transaction, the control server 700 may perform a function of protecting and managing the transactions by fundamentally blocking illegal behaviors so that unfair transactions may not be concluded or illegal behaviors such as fraud may not be performed.

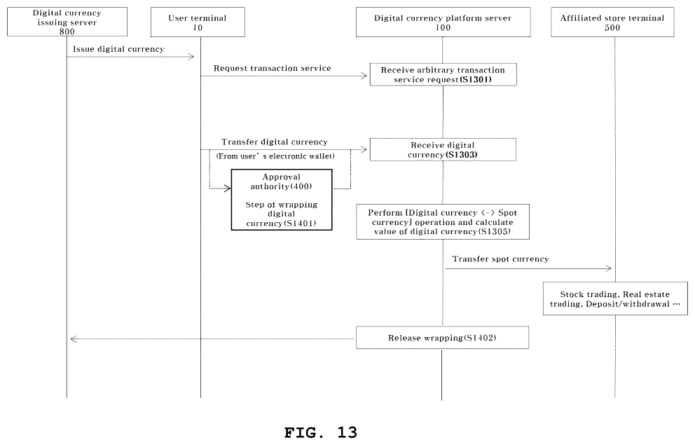

Finally, FIG. 13 shows an embodiment of applying some modifications to FIG. 8 described above, and the step of (c) wrapping the digital currency (S1401) is performed when the approval authority 400 approves change of ownership of the digital currency.

The digital currency wrapping means that when it is assumed that there are various types of digital currencies, various types of digital currencies issued by the digital currency issuing server 800 are packaged into one and transferred to the digital currency platform server 100.

Here, indications showing that the approval authority guarantees the digital currency to be used as the central bank digital currency (CBDC), such as an indication of approval of the approval authority for the change of ownership or a mark of the approval authority, (hereinafter, referred to as wrapping data) may be included in the package. In addition, the wrapping data may include transaction details such as the names of transaction parties, transaction type, transaction purpose, transaction time, and the like. In addition, the wrapping data may include contents about the market price or value of digital currency, such as the market price at the time of wrapping, the ratio of the value of the digital currency concluded between transaction parties, and the like, considering that the value of digital currency varies.

Referring to FIG. 13 again, the digital currency platform server 100 receives the wrapped digital currency (S1303), and thereafter, the digital currency platform server 100 calculates the value of the digital currency on the basis of spot currency according to a predetermined ratio (S1305).

When the digital currency platform server 100 calculates the value of the digital currency on the basis of spot currency according to a predetermined ratio, as the spot currency is transferred to an institution that proceeds a transaction with the user, i.e., the affiliated store terminal 500, the digital currency transaction between the user and the affiliated store terminal 500 is completed.

When the digital currency transaction between the user terminal 10 and the affiliated store terminal 500 is completed through the digital currency platform server 100 as described above, only the wrapped digital currency remains in the digital currency platform server 100 as the spot currency has been transferred to the affiliated store terminal 500, and here, since the wrapped digital currency is a digital currency wrapped with wrapping data including indication of approval of the approval authority and information on the transfer of ownership, a step of releasing the wrapping data of the wrapped digital currency (S1402) may be performed to prevent reuse and misuse of the digital currency for which the transaction has been completed.

When the wrapping data of the wrapped digital currency is released, the digital currency with unwrapped data returns to the previous digital currency, i.e., the digital currency issued by the digital currency issuing server 800. As an easy example, when the user receives a first digital currency and a second digital currency issued and stores the currencies in the user terminal, and the first digital currency and the second digital currency stored in the user terminal are wrapped by an approval authority to be used in a transaction, the wrapping data is wrapped in each wrapped package to be used as a central bank digital currency (CBDC), and when the transaction is completed and the wrapping data is released, the digital currency is returned to the first digital currency and the second digital currency previously issued to the user.

Meanwhile, although it is shown in the drawings that there is only one digital currency issuing server 800, there may be several digital currency issuing servers as needed, and particularly, several servers may exist to issue different types of digital currencies. In addition, the digital currency returned to the original issuing server may be recycled in financial transactions later.

On the other hand, the right for wrapping the digital currency is granted to the approval authority, and the right to release the wrapping data of the wrapped digital currency is granted only to the digital currency platform server 100 to prevent indiscriminate reuse or misuse of the digital currency.

On the other hand, the digital currency platform server 100 may induce the user to proactively manage details of digital currency transactions by allowing the user to select whether to store or completely delete the released wrapping data.

The digital currency platform server and a process of performing transactions on the server are described above. Meanwhile, the present invention is not limited to the specific embodiments and applications described above, and various modifications can be made by those skilled in the art without departing from the gist of the present invention claimed in the claims, and these modified embodiments should not be understood separately from the technical spirit or perspective of the present invention.

1. A method of providing a digital currency platform service by a digital currency platform server, the method comprising the steps of:
receiving inputs for joining a digital currency service from a user terminal;
interconnecting to a specific stock brokerage firm system by a user of the user terminal on the basis of the inputs received from the user terminal;
receiving an input of financial transaction menu selection from the user terminal;
receiving an input of a digital currency amount for a financial transaction from the user terminal;
performing a financial transaction of digital currency on the basis of the input of financial transaction menu selection and the input of the amount; and
generating transaction details according to performing the financial transaction, and distributing the transaction details to a blockchain network,
wherein the digital currency is a Central Bank Digital Currency (CBDC).

2. The method according to claim 1, wherein the transaction details distributed to the blockchain network include at least a user name, a stock brokerage firm bank account number, a digital currency platform service bank account number of the user opened through the digital currency platform server, a change in the digital currency according to performing the financial transaction, and a type of the financial transaction.

3. A method of providing a digital currency platform service by a digital currency platform server, the method comprising the steps of:
receiving a request for an arbitrary transaction service from a user terminal of an arbitrary user;
receiving digital currency—the digital currency is stored in an electronic wallet uniquely assigned to the user—from the user terminal; and
calculating a value of the received digital currency on the basis of spot currency according to a predetermined ratio.

4. The method according to claim 3, further comprising the step of transferring spot currency as much as the calculated value to a trading institution server.

5. The method according to claim 4, wherein the digital currency received from the user terminal is received after an approval procedure for approving change of ownership of the digital currency is executed by a specific approval authority.

6. A digital currency platform system comprising:
a user terminal; and
a digital currency platform server configured to communicate with the user terminal,
wherein the digital currency platform server is configured to perform:
an operation of receiving inputs for joining a digital currency service from the user terminal;
an operation of interconnecting to a specific stock brokerage firm system by a user of the user terminal on the basis of the inputs received from the user terminal;
an operation of receiving an input of financial transaction menu selection from the user terminal;
an operation of receiving an input of a digital currency amount for a financial transaction from the user terminal;
an operation of performing a financial transaction of digital currency on the basis of the input of financial transaction menu selection and the input of the amount; and
an operation of generating transaction details according to performing the financial transaction, and distributing the transaction details to a blockchain network,
wherein the digital currency is a Central Bank Digital Currency (CBDC).

7. The digital currency platform system of claim 6, wherein the transaction details distributed to the blockchain network include at least a user name, a stock brokerage firm bank account number, a digital currency platform service bank account number of the user opened through the digital currency platform server, a change in the digital currency according to performing the financial transaction, and a type of the financial transaction.

8. The digital currency platform system of claim 6, wherein the digital currency platform server is configured to further perform:
an operation of receiving a request for an arbitrary transaction service from the user terminal;
an operation of receiving the digital currency—the digital currency is stored in an electronic wallet uniquely assigned to the user—from the user terminal; and
an operation of calculating a value of the received digital currency on the basis of spot currency according to a predetermined ratio.

9. The digital currency platform system of claim 8, wherein the digital currency platform server is configured to further perform an operation of transferring spot currency as much as the calculated value to a trading institution server.

10. The digital currency platform system of claim 9, wherein the digital currency received from the user terminal is received after an approval procedure for approving change of ownership of the digital currency is executed by a specific approval authority.
